(19) United States
(12) Patent Application Publication
(10) Pub. No.: US 2011/0255932 A1
(43) Pub. Date: Oct. 20, 2011

(54) DAMPING INSERT FOR TOOL HOLDER

(76) Inventors: Harold D. Cook, Dana Point, CA (US); Steven M. Orme, Rancho Santa Margarita, CA (US)

(21) Appl. No.: 13/041,315

(22) Filed: Mar. 4, 2011

Related U.S. Application Data
(60) Provisional application No. 61/310,628, filed on Mar. 4, 2010.

(51) Int. Cl. B23C 5/26; B23P 11/00; B23P 17/04

(52) U.S. Cl. 409/141; 29/447; 29/428

(57) ABSTRACT

A tool holder for a cutting and/or milling machine includes a shank portion configured to be attached to a spindle of the cutting and/or milling machine for mounting the tool holder, and a tool mounting portion for mounting a tool to the tool holder. The tool holder includes a cavity through the shank portion and/or the mounting portion, the cavity being aligned to the rotation axis of the tool holder. The tool holder includes a damping material disposed within the cavity for mitigating harmonic resonance during operation of the cutting and/or milling machine. The damping member may be used in all types and configurations of tool holders.

### CROSS-REFERENCE TO RELATED APPLICATION(S)

This application claims priority to and the benefit of U.S. Provisional Application No. 61/310,628, filed Mar. 4, 2010, the entire contents of which are incorporated herein by reference.

### BACKGROUND

The present invention relates to a tool holder having an internal damping member for mitigating harmonic resonance.

In cutting machines, a spindle may be used to spin a cutting tool that cuts a work piece. The tool is mounted to a tool holder and the tool holder is mounted to the spindle. In high speed cutting operations, misalignment, vibratory forces, and harmonic resonance may cause substantial difficulty in satisfactorily cutting a work product. At higher rotational cutting speeds, the cutting tool may vibrate such that the work piece becomes damaged, the operator may be injured and other problems in the cutting operation may arise. Additionally, when the cutting feed and speed matches the frequency of other components, harmonic resonance may give rise to slight movements such that the final work piece might be out of tolerance. The cutting tool may also vibrate out of the tool holder and cause substantial or catastrophic danger.

Accordingly, there is a need in the art for an improved tool holder.

### SUMMARY

The present invention discusses the needs discussed above, discussed below and those that are known in the art.

A tool holder is disclosed herein with a damping member aligned to a center of gravity of the tool holder. The damping member may be centrally located within the tool holder. For high tolerance and high speed cutting machines, the tool may be mounted to the tool holder by thermally expanding the tool holder, inserting the tool into the tool holder and thermally contracting the tool holder about the tool so as to form a metal to metal friction fit. The heater used to thermally expand the tool holder may provide local heat to the tool holder away from the damping member such that the stability of the damping member is not affected by the heat generated from the heater. Accordingly, the tool holder and tool are set up for a high speed and high tolerance cutting application. Also, the damping member mitigates vibration and harmonic resonance to maintain tolerance of the cutting operation on the work piece.

The damping system discussed herein may be employed in a heat shrink tool holder. It is also contemplated that the various aspects of the system may also be employed in non-heat shrink tool holders.

A tool holder for both single and multi-head cutting and milling machines having a spindle is disclosed. The tool holder may optionally include an automatic tool holder changing mechanism. The tool holder may comprise a body and a damping material. The body may define a shank portion attachable to the spindle for mounting the tool holder to the cutting machine, a circular flange portion disposed adjacent the shank portion for interfacing with the automatic tool holder changing mechanism and a tool mounting portion disposed adjacent the circular flange portion for mounting a tool to the tool holder, the body having a central cavity through one or more of the shank portion, flange portion and the mounting portion. The central cavity may be aligned to a rotation axis of the body. The central cavity may be configured in any geometric shape to accommodate all types of damping material for mitigating harmonic resonance and vibration. The shape of the central cavity may also be contoured, sized and configured to reduce vibration and harmonic resonance.

The damping material may be disposed within the central cavity for mitigating harmonic resonance during operation of the cutting machine. The damping material may be gapped (e.g., air gap) away from the tool mounted to the mounting portion to allow the mounting portion to undergo thermal expansion and contraction for inserting an oversized tool into the mounting portion for frictional engagement therebetween without significantly affecting stability of the damping material.

By way of example and not limitation, the damping material may be a heavy metal, tungsten, cast iron, titanium, plastic, composite, metal, crushed tungsten carbide, fluid, elastomeric material, air, combination thereof, etc. The elastomeric material may be rubber and the heavy metal may be mercury, tungsten or lead. The body may further comprise a central cavity extending through the shank portion, flange portion and the mounting portion which defines the central cavity. The damping material may be disposed within the central aperture.

The tool holder may have coolant channels formed in the central aperture or the wall surrounding the central aperture for flowing coolant fluid, air and/or compressed gas to the tool during cutting operation. A minimum quantity lubrication tube may be routed through the tool holder to the tool.

In another embodiment, a tool holder for both single and multi-head cutting and milling machines having a spindle is disclosed. The tool holder may optionally include an automatic tool holder changing mechanism. The tool holder may comprise a first segment, a tool mounting sleeve and a damping material. The first segment may define a shank portion attachable to the spindle for mounting the tool holder to the cutting machine, a flange portion disposed adjacent the shank portion for interfacing with the automatic tool holder changing mechanism and a stub portion disposed adjacent the flange portion. The first segment may have an optional first central cavity through one or more of the shank portion, flange portion and the stub portion. The optional first central cavity may be aligned to a rotation axis of the first segment.

The tool mounting sleeve may be attachable to the stub portion of the first segment by way of thermal expansion and contraction of the stub portion of the first segment. The tool mounting sleeve may have an optional second central cavity. The damping material may be disposed within at least one of the first and second central cavities for mitigating vibration during operation of the cutting machine.

The damping material disposed in the second central cavity, if any, may be gapped away from the tool mounted to the sleeve to allow the sleeve to undergo thermal expansion and contraction for inserting the tool to the sleeve without significantly affecting stability of the damping material.

The first segment may have a central aperture formed through the shank portion, flange portion and the stub portion defining the first central cavity and for mounting the sleeve. The sleeve may also have a central aperture formed therethrough. The central aperture or wall of the first segment and the central aperture or wall of the sleeve may have coolant channels for flowing coolant fluid to the tool during cutting operation.

An outer diameter of the sleeve may be larger than an inner diameter of the central aperture formed in the stub portion so that the sleeve may be inserted and frictionally engaged to the central aperture by thermally expanding and contracting the central aperture of the stub portion.

In another embodiment, a method of mounting a tool to a tool holder having a heat resistant damping material is disclosed. The method may comprise the steps of providing the tool holder with an aperture for mounting the tool, the tool holder having a damping material aligned to a rotation axis of a body of the tool holder; heating a local area of the tool body (i.e., mounting portion) away from the damping material for enlarging the aperture to insert the tool into the aperture wherein the heat does not affect stability of the damping material; inserting the tool into the local area of the tool body (i.e., mounting portion); and cooling the local area so that the local area of the tool body (i.e., mounting portion) contracts and frictionally engages the tool.

The tool holder may have a hollow portion filled with a damping material for mitigating vibration and harmonic resonance to maintain tolerance of the cutting operation on the work piece. Alternatively, the hollow cavity may remain hollow. By way of example and not limitation, the damping material may be heavy metal, mercury, tungsten, lead, cast iron, titanium, plastic, composite, metal, crushed tungsten carbide, fluid, elastomeric material, air, other gasses, combinations thereof, etc.

### BRIEF DESCRIPTION OF THE DRAWINGS

These and other features and advantages of the various embodiments disclosed herein will be better understood with respect to the following description and drawings, in which like numbers refer to like parts throughout.

FIG. 1 is a perspective view of a tool holder.

FIG. 2 is a cross sectional view of the tool holder shown in FIG. 1.

FIG. 2A is an exploded view of FIG. 2.

FIG. 3 is an exploded side view of the tool holder shown in FIG. 1 with a heater.

FIG. 4 is a cross sectional view of the tool holder shown in FIG. 1 illustrating various diameters of a central aperture.

FIG. 5 is an exploded perspective view of an alternate embodiment of the tool holder.

FIG. 6 is a side view of the tool holder shown in FIG. 5 with heaters for mounting a tool to a sleeve and a sleeve to a first segment.

FIG. 7 is a cross sectional view of the tool holder shown in FIG. 5.

FIG. 8 is an alternate embodiment of the tool holder.

FIG. 9 is an exploded cross sectional side view of the tool holder shown in FIG. 8.

FIG. 9A is a top view of the tool holder shown in FIG. 9.

FIG. 10 is an alternate embodiment of a tool holder.

FIG. 11 is an exploded cross sectional side view of the tool holder shown in FIG. 10.

FIG. 11A is a top cross sectional view of the tool holder shown in FIG. 11.

FIG. 12A illustrates a first embodiment of interconnecting first and second halves of a tool holder.

FIG. 12B illustrates a second embodiment of interconnecting first and second halves of a tool holder.

FIG. 12C illustrates a third embodiment of interconnecting first and second halves of a tool holder.

FIG. 13 is an alternate embodiment of a tool holder.

FIG. 13A is a top cross sectional view of the tool holder shown in FIG. 13.

FIG. 14 is a bottom view of an embodiment of a tool holder.

FIG. 14A is a cross sectional side view of a tool holder shown in FIG. 14.

FIG. 15 is a bottom view of another embodiment of a tool holder.

FIG. 15A is a cross sectional side view of another embodiment of a tool holder shown in FIG. 15.

FIG. 16 is a bottom view of another embodiment of a tool holder.

FIG. 16A is a cross sectional side view of another embodiment of a tool holder shown in FIG. 16.

FIG. 17 is a bottom view of another embodiment of a tool holder.

FIG. 17A is a cross sectional side view of another embodiment of a tool holder shown in FIG. 17.

FIG. 18 is a bottom view of another embodiment of a two part tool holder.

FIG. 18A is a cross sectional side view of another embodiment of a two part tool holder shown in FIG. 18.

FIG. 19 is a bottom view of another embodiment of a two part tool holder.

FIG. 19A is a cross sectional side view of another embodiment of a two part tool holder shown in FIG. 19.

FIG. 20 is a bottom view of another embodiment of a two part tool holder.

FIG. 20A is cross sectional side view of another embodiment of a two part tool holder shown in FIG. 20.

FIG. 21 is a bottom view of another embodiment of a tool holder.

FIG. 21A is a cross sectional side view of another embodiment of a tool holder shown in FIG. 21.

FIG. 22 is a cross sectional side view of a tool holder having a retention knob.

FIG. 23 is a cross sectional side view of another embodiment of a tool holder.

FIG. 24 is a cross sectional side view of a tool holder illustrating a minimum quantity lubrication tube.

FIG. 25 is a cross sectional side view of a tool holder illustrating a setting screw for a minimum quantity lubrication tube.

FIG. 26 is a cross sectional side view of a two part tool holder.

FIG. 27 is a cross sectional side view of another embodiment of a two part tool holder.

FIG. 28 is a cross sectional side view of another embodiment of a two part tool holder.

FIG. 29 is a cross sectional side view of a reinforced shank portion of a tool holder.

FIG. 30 is a cross sectional side view of another embodiment of a tool holder.

FIG. 31 is a cross sectional side view of a self-balancing tool holder.

### DETAILED DESCRIPTION

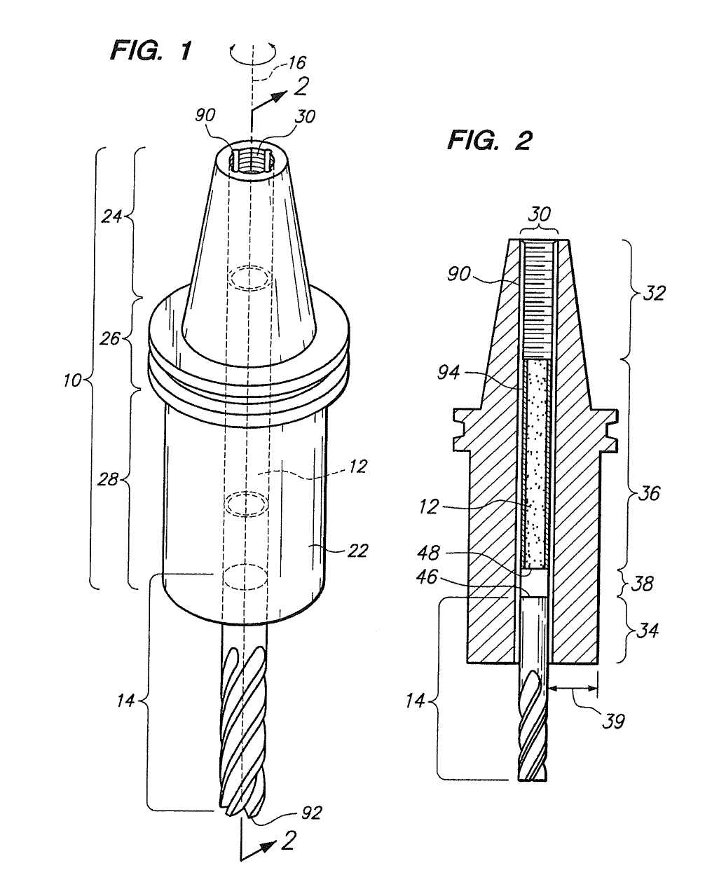

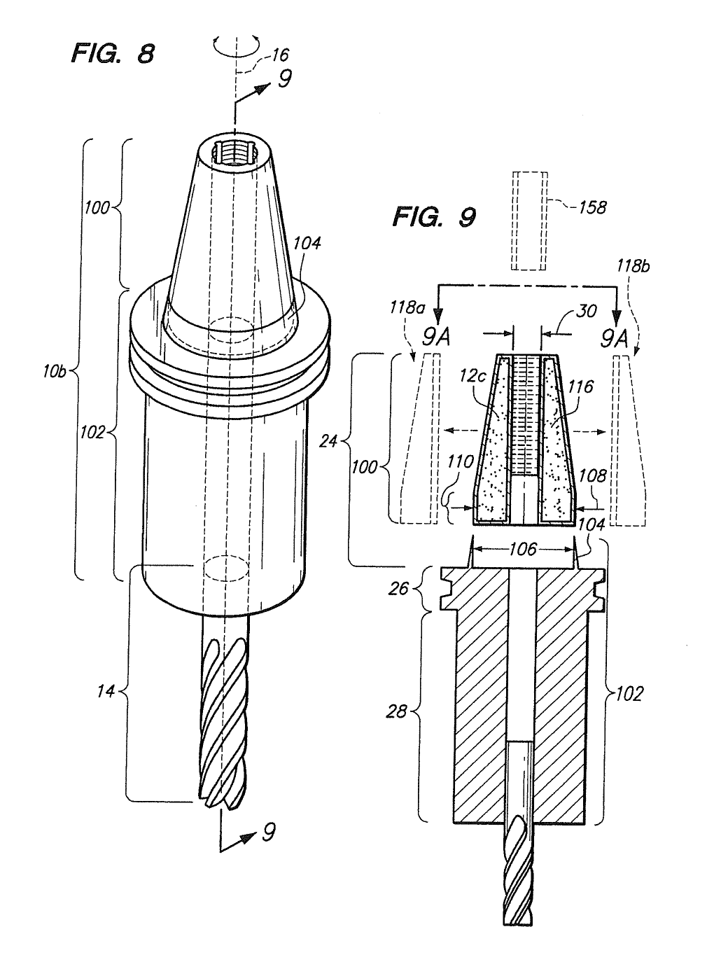

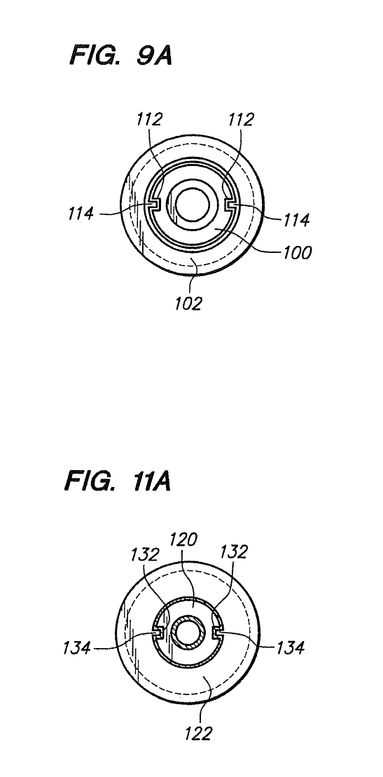

Referring now to FIGS. 1, 2, 2A and 5, a tool holder 10, 10a having a damping member 12 and 12a, b are shown. The tool holder 10, 10a holds a tool 14, 14a that is used to cut a work piece (e.g., block of metal, etc.). The tool holder 10, 10a may be removably mounted to a rotating spindle of a cutting machine. When the tool 14, 14a is attached to the tool holder 10, 10a and the tool holder 10, 10a is mounted to the spindle of the cutting machine, the tool holder 10, 10a and tool 14, 14a may be rotated about the rotation axis 16, 16a of the tool holder 10, 10a. During a cutting operation, the tool holder 10, 10a spins at a certain frequency depending on the cutting operation to be performed on the work piece. If the rotating frequency of the tool holder 10, 10a matches the frequency of the work piece, tool holder 10, 10a or other component of the cutting machine, then undesired events may occur due to harmonic resonance. For example, the tool 14, 14a may be dislodged from the tool holder 10, 10a. Alternatively, the tool 14, 14a may vibrate thereby causing the cutting operation to be out of tolerance. These as well as other undesired events may occur due to the harmonic resonance between the rotating frequency of the tool holder 10, 10a and other components. To mitigate harmonic resonance, the damping member 12 and 12a, b is disposed within the tool holder 10, 10a. It is also contemplated that the damping member 12c may be disposed within a hollow cavity formed in the tool holder 10, as shown in FIGS. 8 and 9.

In addition to reducing or eliminating harmonic resonance, the addition of the damping member may increase dynamic stiffness, which in turn decreases chatter, vibration and forced vibration in the tool holder and tool.

Referring now to FIG. 1, an embodiment of the tool holder 10 has a body 22 that defines a shank portion 24, an optional flange portion 26 and a tool mounting portion 28. The cutting machine may have a spindle that can be attached to the shank portion 24 of the tool holder 10. In particular, the shank portion 24 is used to secure the tool holder 10 to the spindle as well as to align the tool holder 10 to the rotation axis of the spindle. When the tool holder 10 is attached to the spindle, the rotation axis 16 of the tool holder 10 is aligned to the rotation axis of the spindle. The flange portion 26 which is disposed directly adjacent to the shank portion 24 may be utilized by the cutting machine to automatically change out the tool holder 10 and tool 14 with a different tool holder 10 and tool 14. The tool mounting portion 28 disposed directly adjacent to the flange portion 26 is used to mount the tool 14 to the body 22 of the tool holder 10. The shank portion 24, flange portion 26 and the tool mounting portion 28 may be aligned to the rotation axis 16 such that the tool holder 10 does not wobble during rotation of the tool holder 10 by the spindle of the cutting machine.

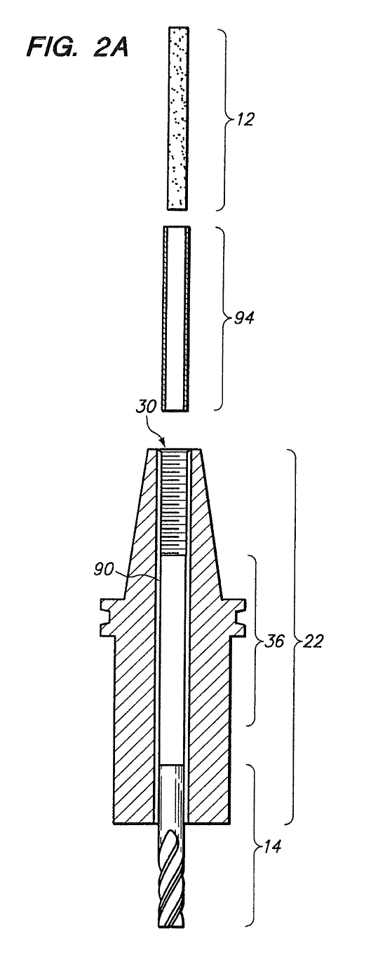

The body 22 of the tool holder 10 may have a central aperture 30 that may extend through the entire body 22 from the shank portion 24 through the flange portion 26 to the tool mounting portion 28. The central aperture 30 may have a generally circular shape and may be the same size throughout the entire body 22 of the tool holder 10. However, any geometric shape is contemplated for the central aperture 30. Referring now to FIG. 2, a first distal end portion 32 of the central aperture 30 may be threaded so as to threadably engage the spindle of the cutting machine to mount the tool holder 10 to the spindle. It is also contemplated that the first distal end portion 32 of the central aperture 30 may not be threaded for those spindles not requiring threads. A second distal end portion 34 of the central aperture 30 may be sized and configured to engage the tool 14. A middle portion 36 of the central aperture 30 may have the damping member 12 located thereat. Although the middle portion 36 of the central aperture 30 is shown as being cylindrical, it is also contemplated that the middle portion 36 of the central aperture 30 may have any shape so long as the weight of the holder 10 is aligned to the rotation axis 16. The damping member 12 mitigates harmonic resonance while the tool 14 is cutting the work piece.

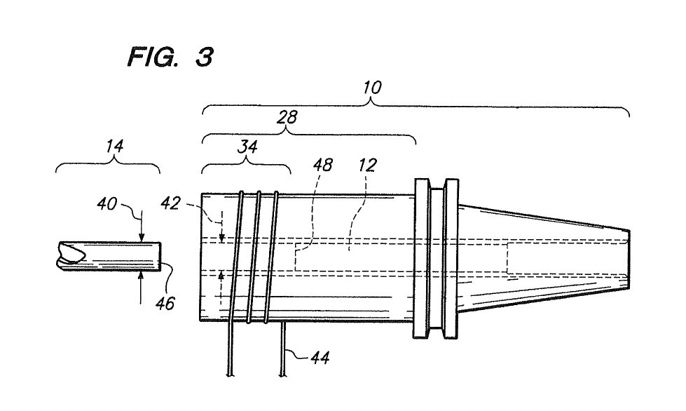

By way of example and not limitation, a gap 38 may exist between the damping member 12 and the tool 14 for the purposes of isolating the damping member 12 from heat required to mount and remove the tool 14 to and from the tool holder 10. The gap 38 is an axial gap. It is also contemplated that a radial gap 39 may exist for the purposes of isolating the damping member 12 from the heat. More particularly, as shown in FIG. 3, an outer diameter 40 of the tool 14 is slightly larger than an inner diameter 42 of the central aperture 30 at the second distal end portion 34. When the tool 14 and the tool holder 10 are at the same temperature, then the tool 14 cannot be inserted into the central aperture 30 at the second distal end portion 34. A heater 44 (e.g., induction heater) may be disposed adjacent the second distal end portion 34 to heat the tool mounting portion 28 of the tool holder 10. The tool mounting portion 28 and the central aperture enlarges due to thermal expansion. The outer diameter 40 of the tool 14 and the inner diameter 42 of the second distal end portion 34 of the central aperture 30 are sized and configured such that upon heating the tool holder 10, the inner diameter 42 of the central aperture 30 becomes larger than the outer diameter 40 of the tool 14. While the tool mounting portion 28 is heated, the tool 14 may now be inserted into the central aperture 30 at the second distal end portion 34. The tool 14 is inserted into the central aperture 30 at the second distal end portion 34 such that a distal end 46 of the tool 14 is gapped away from a distal end 48 of the damping member 12 (see FIGS. 1 and 2). The tool 14 may be removed from the central aperture 30 by heating the tool mounting portion 28 to enlarge the central aperture 30 and allow the tool 14 to be removed. The heater 44 provides local heating to the tool holder 10 to allow insertion and/or removal of the tool 14 into the tool holder 10. The damping member 12 is isolated from the heat generated by the heater 44. When the heater 44 is heating the body 22, the heat is conducted toward the damping member 12. However, the heat from the heater 44 does not significantly affect the stability (e.g., dimensional, chemical, etc.) of the damping member 12 since the damping member 12 is spaced away from the heater 44 radially and/or axially. The damping material may be designed to be heat resistant, and/or the damping member 12 may be gapped away from the applied heat both axially and/or radially so as to protect the damping member from the applied heat. The heater 44 provides only local heating to the tool mounting portion 28 where needed so as to be able to insert the tool 14 into the central aperture 30 at the second distal end portion 34 and minimize thermal impact to the damping material.

As discussed herein, one of two parts being frictionally engaged to each other is heated to an elevated temperature which expands an aperture through such part. The second part is inserted into the aperture of the first part. The first part is allowed to cool to its normal ambient temperature which also contracts or reduces the size of the aperture of the first part thereby frictionally engaging the first and second parts. It is also contemplated that the various aspects discussed herein may be employed with a reverse system. In particular, the second part may be cooled to reduce the diameter of the second part, which is then inserted into the aperture of the first part. The second part is allowed to heat back up to the normal ambient temperature which expands or increases the size of the second part thereby frictionally engaging the first and second parts. Moreover, it is also contemplated to heat the first part and cool the second part then insert the second part into the aperture of the first part. As the first and second parts approach ambient temperature, the parts contract and expand, respectively, thereby frictionally engaging one another. Although the cooling aspect as well as the combination of the cooling and heating aspects are not discussed in relation to each and every embodiment disclosed, it is contemplated that such aspects may also be employed in the other embodiments disclosed herein. In all of these cases, the frictional engagement may be reversed by heating and/or cooling the first and/or second parts to expand and/or contract the parts and allow for disengagement of the parts.

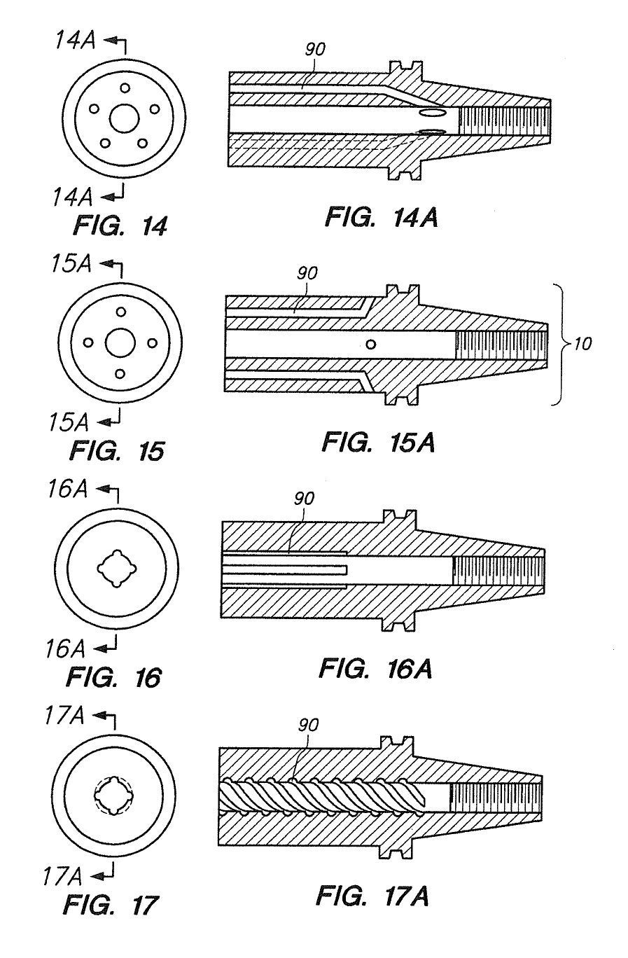

Referring now to FIGS. 1 and 2, the tool mounting portion 28 of the tool holder 10 may have coolant channels 90 formed on walls of the central aperture 30 that extend from the first distal end portion 32 of the central aperture 30 to the second distal end portion 34. The coolant channels 90 may also be formed in the walls of the central aperture 30, as shown in FIGS. 14A, 15A, 18A, 19A and 21A. Referring back to FIGS. 1 and 2, to install the damping member without clogging the coolant channels, the tool holder 10 may have a sleeve 94 inserted into the central aperture 30 to separate the coolant channels 90 from the damping member 12. Referring now to FIG. 2A, the sleeve 94 may be disposed within the body 22, and more specifically, in the middle portion 36 of the central aperture 30. The damping material 12 may then be disposed within the sleeve 94. Since the damping material 12 is being packed in the sleeve 94, the sleeve 94 prevents the damping material 12 from filling and blocking the coolant channel 90. This is one way of inserting the damping member 12 into the central aperture 30. However, other ways are also contemplated within this disclosure as will be discussed below. During the cutting operation, coolant may be fed through the coolant channel 90 which flows downward toward the tool 14. Ultimately, the coolant fluid flows over the distal end 92 of the tool 14 to cool the distal end 92 of the tool 14 during the cutting operation. It is also contemplated that coolant channels may be formed in the walls defining the central aperture 30. It is also contemplated that minimum quantity lubrication tube may be routed through the tool holder to the tool.

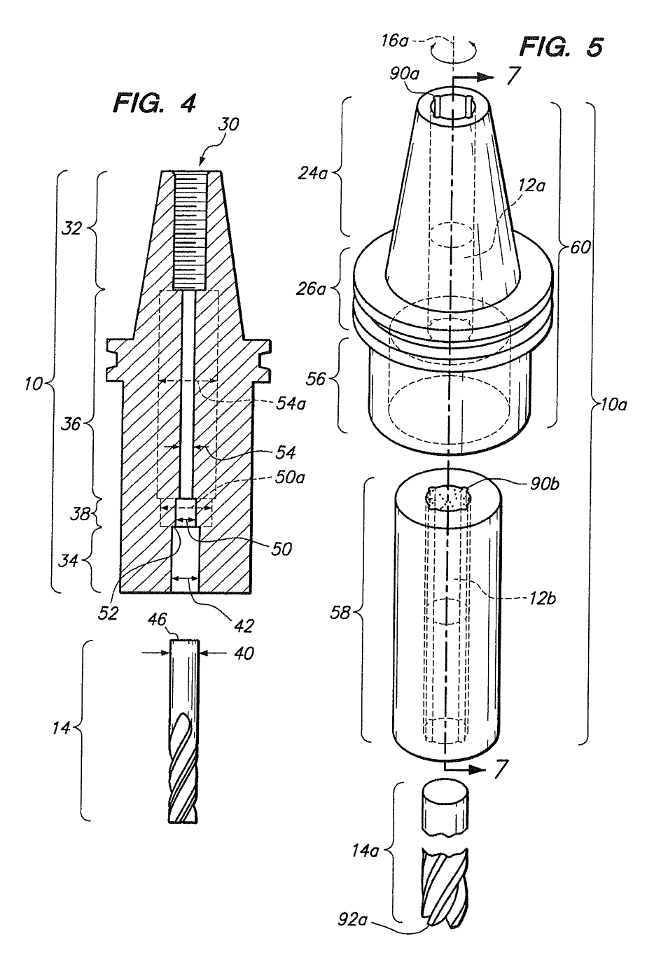

Referring now to FIG. 4, the central aperture 30 formed through the tool holder 10 may have various diameters and/or geometric shapes along its length. For purposes of clarity, the coolant channel 90 is not shown in FIG. 4. By way of example and not limitation, the first distal end portion 32 of the central aperture 30 may optionally be threaded and have a diameter matching a bolt of the cutting machine spindle for attaching the tool holder 10 to the spindle of the cutting machine. The second distal end portion 34 of the central aperture 30 may have an inner diameter 42 that is slightly smaller than an outer diameter 40 of the tool 14 such that the tool 14 can be frictionally engaged to the tool holder 10 by way of thermal expansion and contraction as discussed above. An inner diameter 50 of the gap 38 may be smaller than an inner diameter 42 of the second distal end portion 34. It is also contemplated that the inner diameter 50 of the gap 38 may be greater than the inner diameter 42 of the second distal end portion 34 as shown by dash lines 50a. An inner diameter 54 of the middle portion 36 may be smaller than the inner diameter 50 and/or 42. Alternatively, the inner diameter 54a of the middle portion 36 may be greater than or equal to the inner diameters 50, 42. The damping member 12 may be disposed within the middle portion 36 to fill the entire cavity. Also, it is contemplated that the damping member 12 may fill only a portion of the middle portion 36 and be disposed closer to the first distal end portion 32 compared to the second distal end portion 34 to provide additional axial space between (1) the portion of the tool mounting portion 28 being heated for insertion and removal of the tool 14 to the tool holder 10 and (2) the damping member 12 to maintain stability of the damping member 12. The damping member 12 may be located sufficiently away from the heater 44 such that the damping member 12 is not subjected to temperatures outside of its normal temperature range or temperatures that would affect the stability of the damping member 12. A length, diameter and type of material used for the damping member 12 may be configured for the particular application to mitigate harmonic resonance.

The middle portion 36 of the central aperture may have any variation in shape, size and configuration. The cylindrical shape of the middle portion 36 is shown for the purposes of illustration and not limitation. Additionally, the various aspects of the damping member may be employed with a tool holder without threads formed in the first distal end portion 32.

For non-heat shrink tool holders, when the inner diameter 50 of the gap 38 is smaller than an inner diameter 42 of the second distal end portion 34, a lip 52 is formed. The tool 14 may be inserted into the second distal end portion 34 until the distal end 46 of the tool 14 contacts the lip 52 to regulate insertion depth of the tool 14. No lip is formed when the inner diameter 50 of the gap 38 is equal to or larger than the inner diameter 42 of the second distal end portion 34.

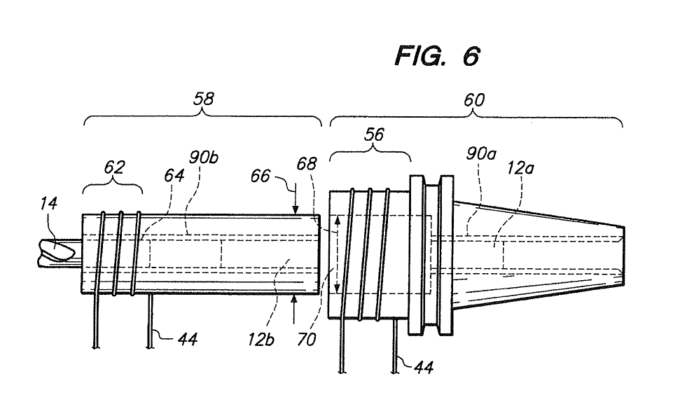

Referring now to FIG. 5, a segmented tool holder 10a is shown. The segmented tool holder 10a may comprise a first segment 60 and a tool mounting sleeve 58. The first segment 60 may comprise a shank portion 24a, an optional flange portion 26a and a stub portion 56 for receiving the tool mounting sleeve 58. The damping member 12a or 12b may be disposed within the first segment 60 of the tool holder 10a and/or the tool mounting sleeve 58. As shown in FIG. 6, the tool 14 may be mounted to the tool mounting sleeve 58 by heating distal end portion 62 by way of heater 44 to expand the central aperture 64 of the tool mounting sleeve 58. If damping member 12b is disposed within the tool mounting sleeve 58, then the heater 44 provides only local heating to the tool mounting sleeve 58 at the distal end portion 62 such that the heat generated by the heater 44 does not affect the stability of the damping member 12b. The damping member 12b is spaced away from the heater 44.

The tool mounting sleeve 58 may be mounted to the first segment 60. In particular, an outer diameter 66 of the sleeve 58 may be slightly larger than an inner diameter 68 of a cavity 70. The heater 44 may be disposed about the stub portion 56 to increase the inner diameter 68 of the cavity 70 such that the tool mounting sleeve 58 may be slid into the cavity 70. If the damping member 12a is disposed within the first segment 60, then the heater 44 and the damping member 12a are spaced apart such that the heat generated by the heater 44 does not affect the stability of the damping member 12a. Since no heat is applied to the tool mounting sleeve 58 when mounting the tool mounting sleeve 58 to the first segment 60, the damping member 12b disposed within the tool mounting sleeve 58 is not significantly affected by the heat generated by the heater 44 disposed about the first segment 60.

Similar to the embodiment 10 discussed above, the tool holder 10a may have coolant channels 90a, b that allow coolant fluid to traverse or flow through the coolant channels 90a, b and flow over the distal end 92a of the tool 14a for cooling the distal end 92a during the cutting operation. Any number of coolant channels 90a, b are contemplated which may be formed in the wall and/or on the inner wall surface along the central aperture 30. The coolant channel 90a formed in the first segment 60 may be aligned to the coolant channel 90b formed in the tool mounting sleeve 58 such that the coolant fluid has a direct path toward the tool 14a. The tool holder 10a may have a sleeve 94 (not shown) in which the damping member 12a, b is disposed to prevent the damping material 12a, b from filling the coolant channels 90a, b in the same manner discussed above in relation to the embodiment of the tool holder 10. It is also contemplated that a minimum quantity lubrication tube may be routed through or adjacent the first segment 60 and/or the tool mounting sleeve 58 to the tool.

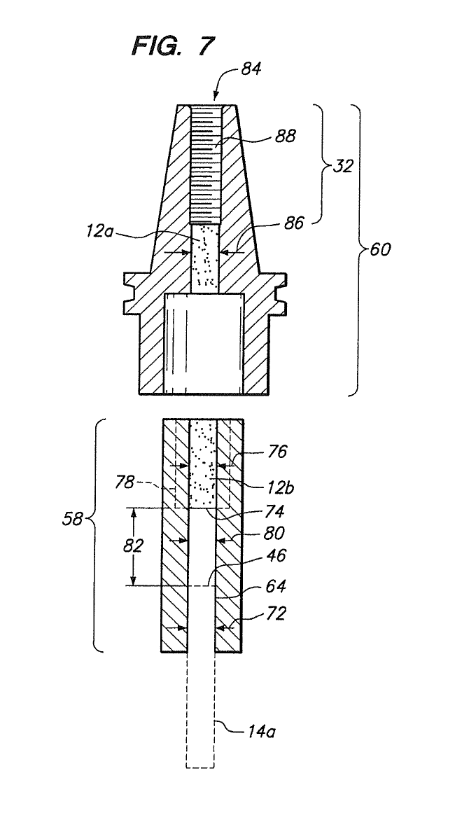

Referring now to FIG. 7, the central aperture 64 of the tool mounting sleeve 58 may have various inner diameters. For the purposes of clarity, the coolant channels 90a, b are not shown in FIG. 7. By way of example and not limitation, the section of the tool mounting sleeve 58 that receives the tool 14a may have an inner diameter 72 that is slightly smaller than an outer diameter 40 of the tool 14a. This allows frictional engagement between the tool 14a and the tool mounting sleeve 58 by way of thermal expansion and contraction of the tool mounting sleeve 58. If damping member 12b is disposed within the tool mounting sleeve 58, then the distal end 46 of the tool 14a may be gapped away from the distal end 74 of the damping member 12b. The inner diameter 76 of the central aperture 64 housing the damping member 12b may be equal to, less than or greater than the inner diameter 72, as shown by dash lines 78. Moreover, the inner diameter 80 of a gap 82 between the damping member 12b and the tool 14 may be less than, greater than or equal to the inner diameter 72. The length, shape and diameter of the damping member 12b may have any configuration so long as the weight of the damping member 12b is aligned to a central rotation axis 16. Also, the damping member 12b may be disposed closer to the first segment 60 as possible so that the heater 44 (see FIG. 6) disposed about the tool mounting sleeve 58 does not affect the stability of the damping member 12b.

It is also contemplated that for non-heat shrink tool holders, if the inner diameter 80 is less than the inner diameter 72, then a lip (not shown) may be formed to regulate the insertion depth of the tool 14a into the tool mounting sleeve 58.

The first segment 60 may have damping member 12a disposed therein. In particular, the damping member 12a may be disposed within central aperture 84. An inner diameter 86 of the through hole 84 may be smaller than, equal to or greater than a first distal end portion 32. The section of the through hole 84 accommodating the damping member 12a and the damping member 12a itself may have complimentary shape, size or geometric configuration. The length, diameters and shape of the damping members 12a, 12b may be sized and configured to mitigate harmonic resonance for the particular cutting application in which the tool holder 10a is being used.

In each of the tool holders 10, 10a, coolant channels 90 and 90a, b (see FIGS. 1 and 5) may be formed along the central aperture 30 or the central apertures 84, 64. Additionally or alternatively, coolant channels 90 and 90a, b may also be formed in the walls along the central aperture 30 or in the walls of the central apertures 84, 64. During operation of the cutting machine, coolant is fed through the coolant channels 90 and 90a, b to flow coolant over the cutting end 92 of the tool 14, 14a. Gas may be flowed through the coolant channels with or without a minimum quantity lubrication tube routed through the tool holder to the tool. There may be two or more (e.g., four) coolant channels 90, 90a, 90b circumferentially spaced at approximately 90 degree interval or spaced equidistant from each other. The damping members 12, 12a, 12b do not impede flow of coolant fluid through the coolant channels 90 and 90a, b. The coolant fluid may be introduced into the tool holder 10 via coolant channels 90 or into the tool holder 10a through the coolant channels 90a, b. The coolant fluid flows past the damping members 12 and 12a, b to the tool 14.

The coolant channels 90, 90a, b may be formed in the following manner. As discussed above and shown in FIG. 2A, grooves may be formed in the walls of the central aperture 30. When the damping material 12 is disposed within the middle portion 36, the damping material 12 may initially be disposed within a sleeve 94. The sleeve 94 and damping material 12 may then be inserted through the central aperture 30 and located at the middle portion 36. In this way, the damping material does not fill the grooves inadvertently. Alternatively, the damping material 12 may be directly inserted into the middle portion 36 of the central aperture 30. No sleeve 94 is used. In this step, the damping material will fill up the coolant channels 90 such that coolant will not be able to flow through the coolant channels 90. A through hole may be drilled, or somehow formed to reopen the coolant channels 90. In a further alternative method of forming the coolant channels and disposing the damping material 12 in middle portion 36 of the central aperture 30, a removable tube, elongate member or removable filler member may be initially disposed within the coolant channels 90. The damping material may then be filled and disposed within the middle portion 36 of the central aperture 30. The filler members are then removed to provide an opening at the location of the coolant channels 90.

It is also contemplated that a sleeve may be disposed in the middle of the middle portion 36 of the central aperture 30. Damping material is applied to the periphery of the sleeve and may fill the coolant channels 90 at the middle portion 36. The coolant may flow through a retention knob at the first distal end portion 32, flow through the center of sleeve and flow through the coolant channels 90 at the second distal end portion 34.

The tool holders 10, 10a disclosed herein may be particularly useful for high tolerance machining applications. By way of example and not limitation, the metal to metal friction fit by shrink fitting the tool 14 to the tool holder 10 or the tool 14 to the tool mounting sleeve 58 provides high tolerance for those high tolerance, high speed machining applications. The damping members 12 and 12a, b mitigate harmonic resonance and/or vibration that might cause the high tolerance machining application to move out of tolerance.

The damping members 12 and 12a, b may be any material that will mitigate vibration and harmonic resonance, such as but not limited to, heavy metal (e.g., mercury, tungsten, or lead), a combination of heavy metals, composite material, elastomeric material, crushed tungsten carbide, metal, cast iron, titanium, plastic, air, other gasses, or a combination thereof. Considerations such as chemical resistance and durability factor into the choice of the damping material. In one embodiment, Viton®, a fluoroelastomer, is used as the damping material. The heater 44 may raise the temperature of the tool holder 10, first segment 60 or the sleeve 58 to a temperature to facilitate mounting of the tool to the tool holder 10 or the sleeve 58 to the first segment 60. However, if a heavy metal material is used as the damping material, then it is further contemplated that the maximum temperature to which the tool holder 10, first segment 60 and/or the sleeve 58 may be heated through the use of the heater 44 will be maintained below a prescribed limit to avoid triggering any adverse reactions from such heavy metal materials.

The heater 44 shown herein is an induction heater. However, other types of heaters are also contemplated for the purposes of heating the tool holder 10, first segment 60 and/or the sleeve.

Referring now to FIGS. 8-13A, another embodiment of a tool holder 10b operative to dampen vibration and harmonic resonance is shown. The tool holder 10b may comprise first and second segments 100, 102 that are removably attachable to each other, for example by friction fit, threaded joints, set screws, shrink fit, mechanical means, or any other type of removable attachment. It is also contemplated that the first and second segments 100, 102 may be permanently attached to each other such as through adhesives, welding, etc. Referring now to FIGS. 8, 9 and 9A, the tool holder 10b has first and second segments 100, 102. The second segment 102 may include flange portion 26 (optional) and the tool mounting portion 28. The first segment 100 may include the shank portion 24. A supporting structure 104 (see FIG. 9) may extend from the flange portion 26 of the second segment. An inner diameter 106 of the supporting structure 104 may be slightly less than an outer diameter 108 of a base 110 of the first segment 100. In this manner, the supporting structure 104 may be heated to enlarge the inner diameter 106 and heat shrink the supporting structure 104 into engagement with the base 110 of the first segment 100 for attaching the first and second segments 100, 102 together. Alternatively, the inner diameter 106 may be equal to or greater than the outer diameter 108 of the base 110 of the first segment 100. In this event, the first and second segments 100, 102 may be attached to each other by friction fit, set screws, shrink fit, welding, brazing, adhesive, etc., and other methods known in the art to prevent axial separation of the first and second segments 100, 102 as well as relative rotational movement of the first and second segments 100, 102 during rotation of the tool holder 10b. To prevent rotational movement between the first and second segments 100, 102, as shown in FIG. 9A, the base 110 of the first segment 100 may have notches 112. The supporting structure 104 of the second segment 102 may have tabs 114 that are disposable within the notches 112. The mating notches 112 and tabs 114 prevent the first and second segments 100, 102 from rotationally slipping during the cutting operation.

The first segment 100 may be hollow as shown in FIG. 9 so as to define internal cavity 116. The internal cavity 116 may be filled with a damping material 12c. By way of example and not limitation, the damping material 12c may be elastomeric material, crushed tungsten carbide, a honeycomb structure with or without damping material, a composite material, a plastic material, a fluid, air or combinations thereof. A honeycomb structure may further reduce harmonic resonance and vibrations. Alternatively, the internal cavity 116 may remain hollow. Generally, more damping material in the internal cavity 116 increases the dynamic stiffness. Alternatively, to provide damping and add rigidity and mass, a solid tube 158 may be inserted into the central aperture 30 of the first segment 100. The solid tube 158 may be fabricated from heavy metal, lead, cast iron, titanium, tungsten, heavy metal, steel, composite, plastic or combinations thereof. The solid tube 158 may be modified for optimal results.

It is further contemplated that the first segment 100 may be formed in two parts or two halves 118a, b, as shown in the hidden lines in FIG. 9.

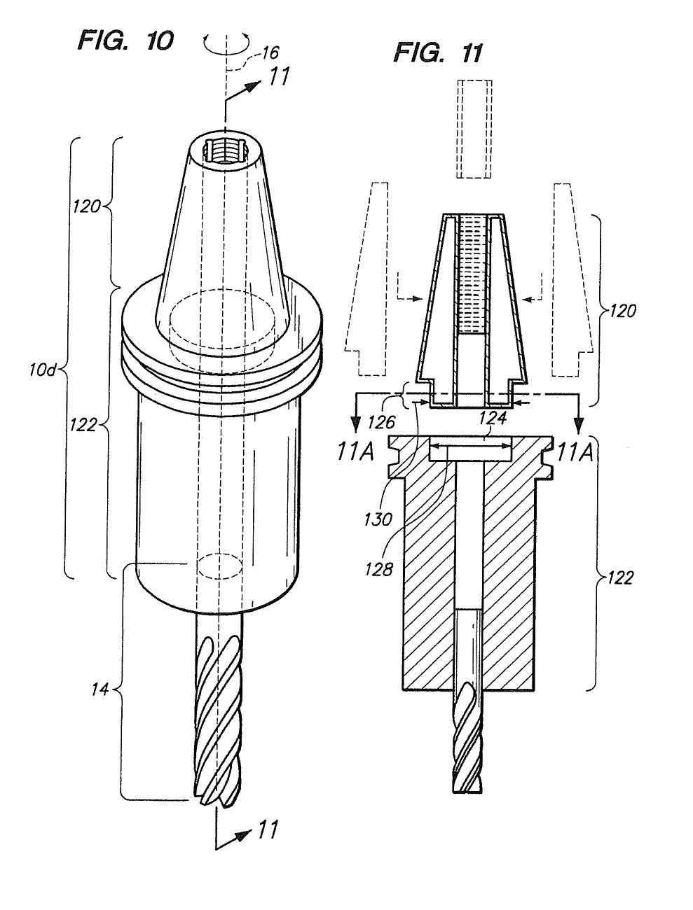

Referring now to FIGS. 10, 11 and 11A, a third embodiment of a tool holder 10d is shown. The third embodiment of the tool holder 10d includes first and second segments 120, 122. The first and second segments 120, 122 are attachable to each other by a semi permanent or permanent bond or by mechanical means. In particular, the second segment 122 includes a recess 124 which receives a base 126 of the first segment 120. An inner diameter 128 of the recess 124 may be slightly smaller than an outer diameter 130 of the base 126 of the first segment 120. The second segment 122 may be heated as discussed above to increase the inner diameter 128 to shrink fit the recess 124 of the second segment 122 over the base 126 of the first segment 120. Alternatively, the inner diameter 128 of the recess 124 may be equal to or slightly greater than the outer diameter 130 of the base 126 of the first segment 120. To attach the first and second segments 120, 122, the base 126 may be friction fitted, threaded, set screwed, shrink fitted, adhered, brazed, or welded within the recess 124 of the second segment 122. To prevent rotational movement between the first and second segments 120, 122 during use or the cutting operation, the first segment 120 may have notches 132 that receive tabs 134 of the second segment 122, as shown in FIG. 11A. It is also contemplated that the first and second segments 120, 122 may be permanently attached to each other such as through adhesives, welding, etc.

The outer wall of the tool holder may be manufactured from materials such as, but not limited to, heavy metal, composites, steel, 8620 or H13 tool steel, stainless steels, tungsten, and combinations thereof.

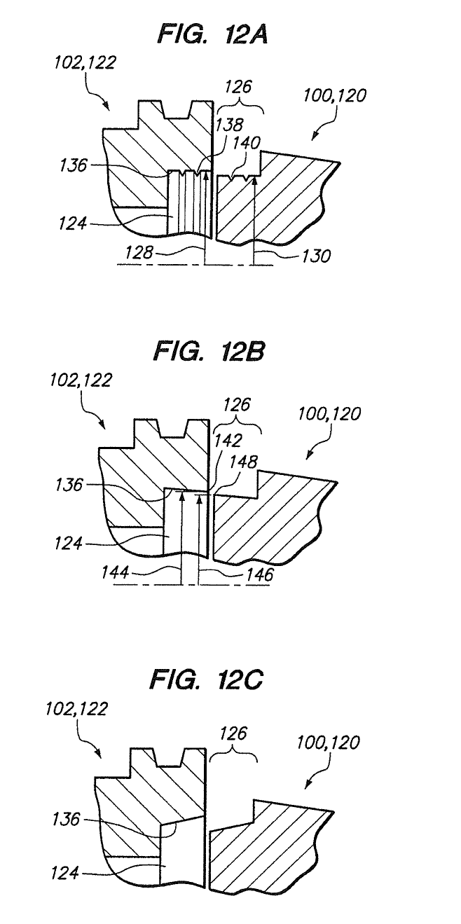

Referring now to FIGS. 12A-12C, the first and second segments 100, 120, 102, 122 may be attached to each other as shown in FIGS. 12A-12C. These are examples of how to attach the first and second segments 100, 120, 102, 122 but other configurations are also contemplated. Although the specific structure of the first and second segments 100, 120, 102, 122 shown in FIGS. 12A-C reflect the embodiment of tool holder 10d, the various aspects discussed in relation to FIGS. 12A-12C may also be employed in the tool holder 10b. Referring now to FIG. 12A, an inner surface 136 of the recess 124 may have one or more protrusions 138 that mate with corresponding grooves 140 formed in the base 126. The second segment 102, 122 may be heated to increase the inner diameter 128 of the recess 124 until the apexes of the protrusions 138 clear the outer diameter 130 of the base 126. The first segment 100, 120 is inserted into the recess 124. The second segment 102, 122 is allowed to cool down and contract upon and around the base 126. The protrusions 138 and grooves 140 prevent axial pullout of the first segment 100, 120 from the second segment 102, 122. The protrusions 138 and grooves 140 may be formed on the supporting structure 104 and the base 110 discussed in relation to the embodiment of the tool holder 10b shown in FIGS. 8 and 9. It is also contemplated that the protrusions 138 and grooves 140 may be formed on the first segment 100, 120 and the second segment 102, 122 or in reverse orientation.

Referring now to FIG. 12B, the recess 124 may have a frusto conical inner surface 136. To attach the first segment 100, 120 to the second segment 102, 122, the second segment 102, 122 may be heated until an inner diameter 144 of a distal edge 142 is greater than an outer diameter 146 of a distal edge 148 of the base 126. When the second segment 102, 122 is allowed to cool down, the inner surfaces 136 frictionally engages the base 126 to prevent axial pullout as well as rotation.

The first and second segments 100, 120, 102, 122 discussed in relation to FIGS. 12A and 12B may additionally be attached to each other by friction fit, threaded joints, set screws, shrink fit, braising, welding, adhesive, mechanical means, etc.

Referring now to FIG. 12C, the first and second segments 100, 120, 102, 122 may be attached to each other. The inner surface 136 is splayed outwardly such that the base 126 can be freely inserted or removed from the recess 124. To attach the first and second segments 100, 120, 102, 122, the first and second segments may be friction fitted, threaded, set screwed, shrink fitted, adhered, brazed, welded, attached by mechanical means, etc. to prevent axial disengagement as well as rotational relative movement.

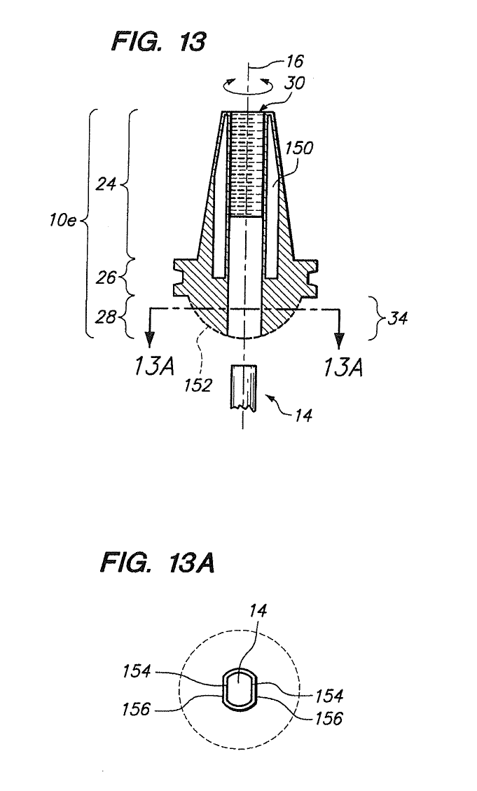

Referring now to FIG. 13, another embodiment of a tool holder 10e is shown. The tool holder 10e may be a unitary construction or a multi piece construction. By way of example and not limitation, the shank portion 24 may be a separate piece from the flange portion 26 (flange portion 26 is optional) and tool mounting portion 28, as discussed in relation to FIGS. 8-12. A hollow cavity 150 can remain hollow or be filled with damping material as discussed above in relation to FIGS. 8-11. When hollow, the air or gas is the damping material. Various types of gases may be utilized as the damping material such as air, oxygen, nitrogen, inert gas, etc. The exterior surface 152 of the tool mounting portion 28 is shown in hidden lines in FIG. 13. This demonstrates that the exterior surface 152 may have any shape and configuration as long as the weight of the tool holder 10e is symmetrical about rotation axis 16. The tool holder 10e may be any type of tool holder, including a shrink fit tool holder. In the case of a shrink fit tool holder, the tool 14 may be inserted into the second distal end portion 34 of the central aperture 30 by heating the tool mounting portion 28 to enlarge the second distal end portion 34 on the central aperture 30, slip the tool 14 into the central aperture 30 and allow the tool mounting portion 28 to cool down such that the central aperture frictionally engages the tool 14 to prevent axial pullout as well as rotation. To further enhance or mitigate relative rotational movement between the tool 14 and the tool holder 10d, the tool 14 may have opposing flat surfaces 154, as shown in FIG. 13A. The second distal end portion 34 of the central aperture 30 may additionally have corresponding flat surfaces 156 to prevent rotation of the tool 14 within the second distal end portion 34 of the central aperture 30. It is also contemplated that the tool may be removed from the second distal end portion 23 by heating the tool and the second distal end portion to allow the second distal end portion to expand and release the tool. The tool may then be removed from the second distal end portion.

Coolant channels may also be incorporated in the embodiment shown in FIGS. 8-13A but are not shown for the purposes of clarity. The coolant channels may be formed as discussed above in relation to FIGS. 1-7. It is also contemplated that minimum quantity lubrication tube may be routed through the tool holder.

The damping material discussed herein may be any solid material identified herein such as plastic, metal, etc. However, it is also contemplated that the damping material may also be gas. By way of example and not limitation, referring to FIG. 13, the cavity 150 may be left empty with gas and not be filled with a solid damping material. By way of example and not limitation, the gas may be air, inert gas, etc.

Moreover, it is contemplated that the damping material 12, 12 a, b, c may be layered. The interface between layers helps to increase the damping characteristics. Each layer may be fabricated from a different type of material or may be fabricated from the same material but have a distinct boundary between adjacent layers. Each interface between different materials may alter the transmission of vibration waves between the materials with some having a greater reduction than others. Also, certain damping materials that are fragile may be disposed between damping materials that are sturdier to protect the more fragile damping material.

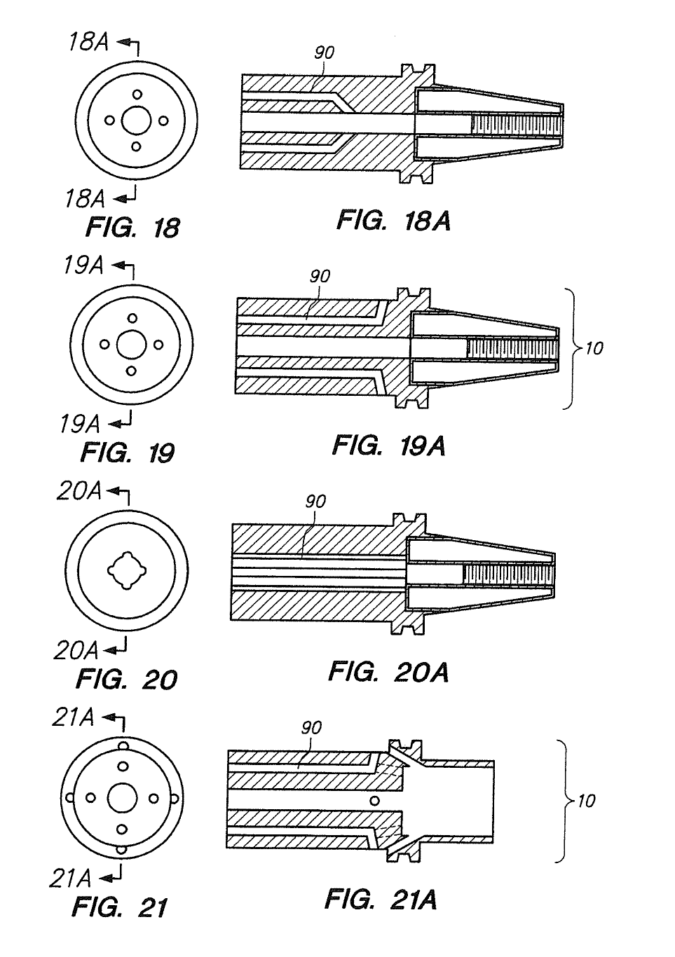

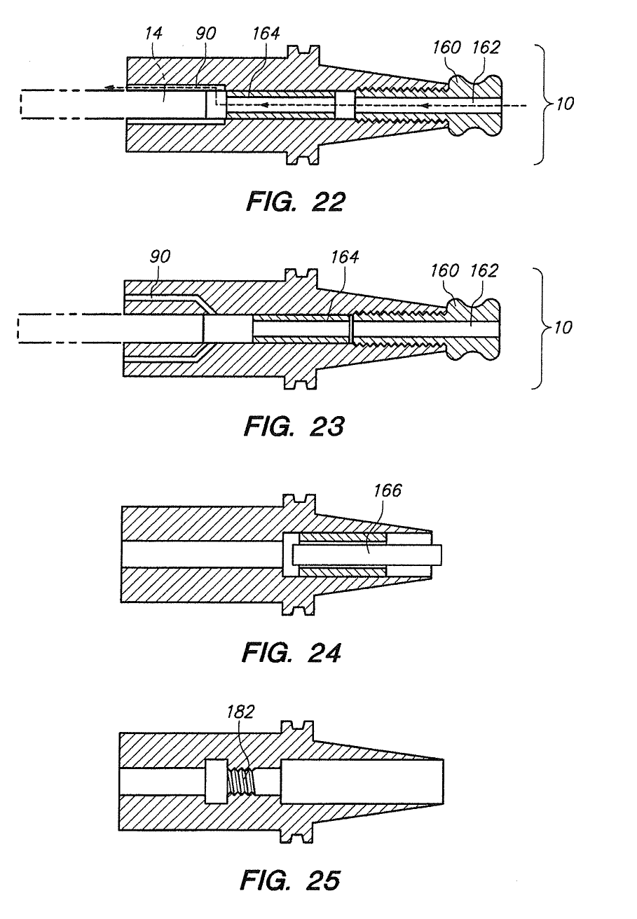

Coolant may flow through the tool holder either from a side of the tool holder (see FIGS. 15A, 19A and 21A) or through a retention knob (see FIGS. 22 and 23). When the coolant enters through the retention knob 160, coolant channels are not necessarily formed on the inner surface of the central aperture near the retention knob 160 since the retention knob 160 blocks any flow of coolant therethrough. The coolant enters through the aperture 162 of the retention knob 160, through a sleeve 164, through a gap between the tool 14 and the sleeve 164 and into the channels 90 until the coolant reaches the distal cutting end of the tool 14. A two part tool holder wherein the coolant flows through the coolant channels 90 formed on the wall is shown in FIG. 20a. It is also contemplated that the coolant may pass through coolant channels shown in FIG. 18A formed in the walls.

The coolant channels 90 may be formed in the walls of the tools holder 10. In FIG. 14A, the coolant channels 90 initiate from the inner surface of the tool holder 10 and proceed into the walls and exit out of the end of the tool holder 10. It is also contemplated that the coolant channels 90 may proceed from the end of the tool holder 10 at the tool end of the tool holder and may proceed partially into the tool holder on the wall of the tool holder, as shown in FIG. 16A. It is also contemplated that the coolant channels may be formed in a spiral shape and not linear as shown in FIG. 16A.

As discussed above, a minimum quantity lubrication system may be used to cool the tool. To this end, the minimum quantity lubrication system includes a minimum quantity lubrication tube, or MQL tube. The MQL tube 166 may be routed through the central aperture of the tool holder 10 to the tool 14 as shown in FIG. 24. The MQL tube 166 may be routed through the central aperture of the tool holder 10 wherein the central aperture has threads 182 (see FIG. 25) for a coolant delivery set.

Referring to FIG. 23, the sleeve 164 may be positioned within the central aperture so that the coolant may flow through the coolant channels 90 located in the wall of the tool holder.

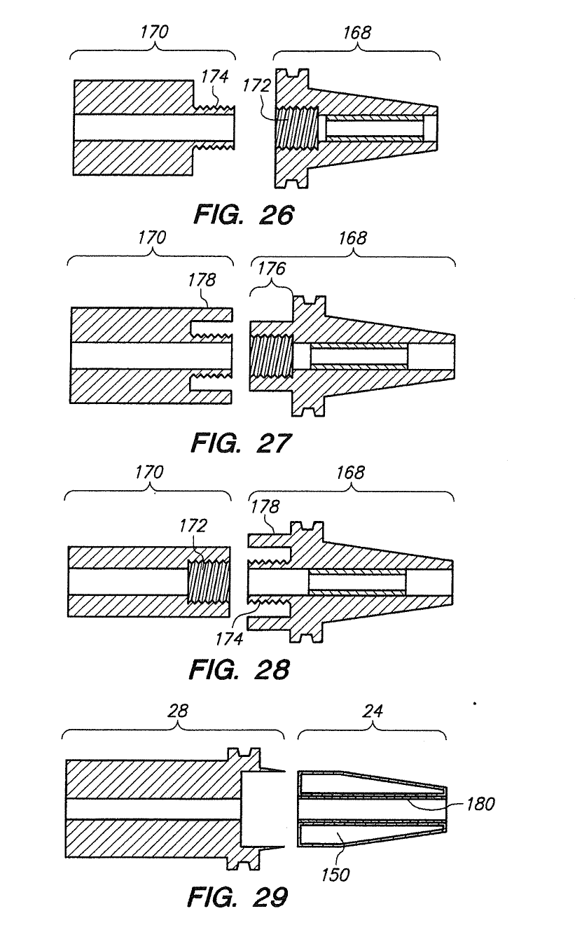

Referring now to FIGS. 26-28, the tool holder may comprise first and second segments 168, 170 that are permanently or semi-permanently attached to each other. In FIG. 26, the first segment 100 has internal threads 172 and the second segment 170 has external threads 174 which are threadably engageable to the threads 172. Adhesives, bonding, welding and the like may be used to prevent the threads 172 and 174 from loosening or becoming disengaged from one another. Alternatively, the threads 172 and 174 may be configured to tighten against each other when the tool holder is in use. In FIG. 27, the first and second segments 168 and 170 have similar construction compared to the first and second segments 168, 170 shown in FIG. 26. A flange 178 circumscribes a protrusion 176. In FIG. 28, the flange 178 is disposed on the first segment 168 instead of the second segment 170. Also, the internal threads 172 are formed on the second segment 170. The external threads 174 are formed on the first segment 168. In the embodiments discussed in relation to FIGS. 26-28, it is contemplated that the first segment 168 may be left in the spindle while the second segment 170 is detached and replaced as desired for quick change ups.

Referring now to FIG. 29, a shank portion 24 is separate from a tool mounting portion 28. The shank portion 24 may have a hollow cavity 150. To add strength back to the shank portion 24, a reinforcing sleeve 180 which may also behave as a damping material may be inserted into the central aperture.

The tool mounting portion of the two part tool holders described herein may be elongated so as to function as an extension. Furthermore, in relation to FIGS. 26-28, a damping member may be incorporated into the first segments 168 such as the various damping materials and configurations discussed herein. Additionally, the tool holders described herein are related to a multi part tool holder. In particular, the embodiments described herein have first and second parts that are removably attachable to each other. It is also contemplated that additional parts such as extensions and adaptors may be removably attachable to the tool holder for the purposes of extending, switching out tools, etc. In particular, adapters and tool holders such as right angle adapters, multi-piece tool holders, tool holder adapters, tool holders with angled drive heads and any type of tool holder with a permanent or temporary attachment may be used.

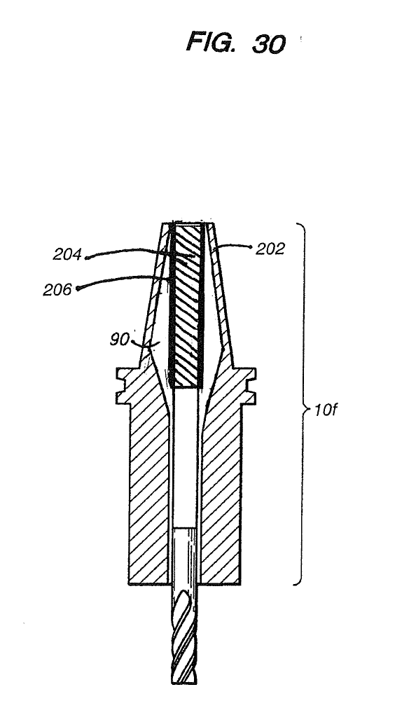

In another embodiment of the tool holder shown in FIG. 30, a thin wall tapered shank 202 allows the taper to be preloaded when it is pulled into the spindle. Adding a central shaft 204 or tube serves to strengthen the tool holder 10f and create a coolant channel 90. The wall 206 of this central shaft may be manufactured from heavy metals to increase the central weight and natural balance of the tool holder 10f, resulting in an increased mass in the center of the tool holder and an axially balanced mass.

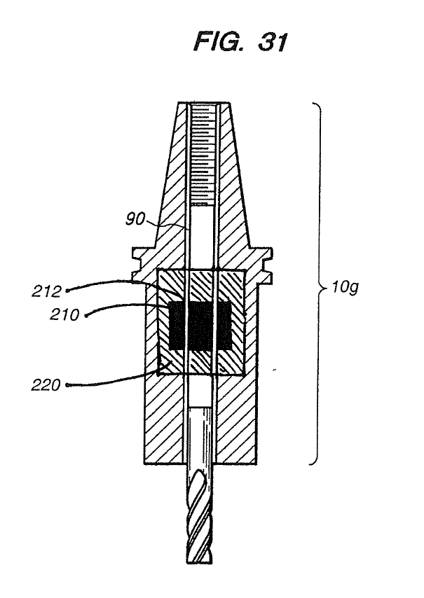

In another embodiment of the tool holder shown in FIG. 31, a block 210 of heavy metal, for example lead or tungsten, having at least one bore 212 for the coolant channel 90, is suspended by a suspension material 220. The block 210 will move as needed to self-balance the tool holder 10g. The suspension material 220 may be an elastomeric material, an elastomeric web, or any material suitable to suspend the block 210 and allow it to move in any direction required to automatically balance the tool holder 10g.

The above description is given by way of example, and not limitation. Given the above disclosure, one skilled in the art could devise variations that are within the scope and spirit of the invention disclosed herein, including various ways of forming the coolant channels 90 and 90a, b. Further, the various features of the embodiments disclosed herein can be used alone, or in varying combinations with each other and are not intended to be limited to the specific combination described herein. The damping member discussed herein may be employed with any type of tool holder (e.g., heat shrink, non-heat shrink, Capto, HSK, BT, CAT, long tool holders, narrow tool holders, concave and convex curved tool holders, increased mass tool holders, reduced mass tool holders, tool holders with balancing screws and/or balancing rings, and any other tool holders) and is not be restricted to any particular type of tool holder. In addition, the various features of the embodiments disclosed herein may be used in conjunction with spindles with drive keys, spindles without drive keys, tabbed spindles, non-tabbed spindles, or any other type of spindle. Thus, the scope of the claims is not to be limited by the illustrated embodiments.

What is claimed is:

1. A tool holder for a cutting and milling machine having a spindle, the holder comprising:
a body defining a shank portion configured to be attached to the spindle for mounting the tool holder to the cutting and milling machine and a tool mounting portion for mounting a tool to the tool holder, the body having a cavity through one or more of the shank portion and the mounting portion, the cavity being aligned to a rotation axis of the body; and
a damping material disposed within the cavity for mitigating harmonic resonance during operation of the cutting and milling machine.

2. The tool holder of claim 1 wherein the damping material is gapped away from the tool mounted to the mounting portion to allow the mounting portion to undergo thermal expansion and contraction or thermal contraction and expansion for inserting a tool into the mounting portion for frictional engagement therebetween without significantly affecting stability of the damping material.

3. The tool holder of claim 1 wherein the body has a first segment having the shank portion, a second segment having the mounting portion and optional additional segments, the hollow cavity being formed in the shank portion.

4. The tool holder of claim 3 wherein the first and second segments and optional additional segments are sized and configured so as to be attached to each other through thermal expansion and contraction, threaded engagement, adhesive, welding, brazing, mechanical engagement or a combination thereof.

5. The tool holder of claim 1 wherein the weight of the damping material is centered about the rotation axis of the body.

6. The tool holder of claim 2 wherein the gap is an air gap.

7. The tool holder of claim 1 wherein the damping material comprises a material selected from the group consisting of plastic, heavy metal, composite, elastomeric material, metal, crushed tungsten carbide, fluid, titanium, cast iron, lead, tungsten, mercury, a honeycomb structure, air and a combination thereof.

8. The tool holder of claim 1 wherein the damping material is selected from the group consisting of rubber, lead, and a combination thereof.

9. The tool holder of claim 1 wherein the damping material is a layered damping material.

10. The tool holder of claim 1 wherein the body further has a central aperture extending through the shank portion and the mounting portion which defines the hollow cavity.

11. The tool holder of claim 1 wherein the shank portion is hollow which defines the hollow cavity.

12. The tool holder of claim 1 wherein coolant channels are formed on and/or in a wall of the tool holder for flowing coolant to the tool during cutting operation.

13. The tool holder of claim 12 wherein the coolant channels are formed in a wall defining a central aperture defining the hollow cavity extending through the shank portion and the mounting portion for flowing coolant to the tool during cutting operation.

14. The tool holder of claim 1 wherein a minimum quantity lubrication tube is routed to the tool during the cutting operation.

15. The tool holder of claim 1 wherein the damping material has a central aperture for flowing coolant therethrough.

16. A tool holder for a cutting and milling machine having a spindle, the holder comprising:
a first segment defining a shank portion attachable to the spindle for mounting the tool holder to the cutting and milling machine and a stub portion, the first segment having an optional first central cavity through one or more of the shank portion and the stub portion, the optional first central cavity being aligned to a rotation axis of the first segment;
a tool mounting sleeve attachable to the stub portion of the first segment, the tool mounting sleeve having an optional second central cavity; and a damping material disposed within at least one of the first and second central cavities for mitigating vibration during operation of the cutting machine.

17. The tool holder of claim 16 wherein the damping material disposed in the second central cavity is gapped away from the tool mounted to the sleeve to allow the sleeve to undergo thermal expansion and contraction for inserting the tool to the sleeve without significantly affecting stability of the damping material.

18. The tool holder of claim 16 wherein the first segment has a central aperture formed through the shank portion and the stub portion defining the first central cavity and a cavity for mounting the sleeve.

19. The tool holder of claim 16 wherein the sleeve has a central aperture formed therethrough, and the central aperture of the first segment and the central aperture of the sleeve both have coolant channels for flowing coolant to the tool during cutting operation.

20. The tool holder of claim 16 wherein the sleeve has a central aperture formed therethrough, and the wall defining the central aperture has coolant channels located therein for flowing coolant to the tool during cutting operation.

21. The tool holder of claim 16 wherein the stub portion and the tool mounting sleeve are sized and configured so as to be attached to each other through thermal expansion and contraction, threaded engagement, adhesive, welding, brazing, mechanical engagement or a combination thereof.

22. The tool holder of claim 16 wherein an outer diameter of the sleeve is larger than an inner diameter of the central aperture formed in the stub portion so that the sleeve is inserted and frictionally engaged to the central aperture by thermally expanding and contracting the central aperture of the stub portion.

23. The tool holder of claim 16 wherein the tool mounting sleeve is attached to the stub portion of the first segment by way of thermal expansion and contraction of the stub portion of the first segment.

24. The tool holder of claim 16 wherein the first segment and the tool mounting sleeve have mating threads for threaded engagement therebetween.

25. The tool holder of claim 16 wherein the first segment has a first engagement portion and the tool mounting sleeve has a second engagement portion, wherein the first and second engagement portions are selected from mating tabs and notches.

26. The tool holder of claim 16 wherein the damping material comprises a material selected from the group consisting of plastic, heavy metal, composite, elastomeric material, metal, crushed tungsten carbide, fluid, titanium, cast iron, lead, tungsten, mercury, a honeycomb structure, air and a combination thereof.

27. The tool holder of claim 16 wherein the damping material is a solid tube is inserted into the first central cavity.

28. The tool holder of claim 27 wherein the solid tube comprises a material selected from the group consisting of lead, cast iron, titanium, tungsten, heavy metal, steel, composite, plastic, an a combination thereof.

29. A method of mounting a tool to a tool holder having a damping material, the method comprising the steps of:
providing the tool holder with an aperture for mounting the tool, the tool holder having a damping material aligned to a rotation axis of a body of the tool holder;
heating a local area of the tool mounting portion away from the damping material for enlarging the aperture to insert the tool into the aperture wherein the heat does not affect stability of the damping material;
inserting the tool into the local area of the tool mounting portion; and
cooling the local area so that the local area of the tool body contracts and frictionally engages the tool.

30. The method of claim 29 wherein the damping material is heat resistant.

31. A method of forming a damping material within a central aperture of a tool holder, the method comprising the steps of:
forming coolant channels on walls defining the central aperture;
inserting elongate rods into the formed coolant channels;
disposing a damping material into the central aperture; and
removing the elongate rods from the formed coolant channels.
